(19) United States
(12) Patent Application Publication
(10) Pub. No.: US 2024/0092375 A1
(43) Pub. Date: Mar. 21, 2024

(54) AUTONOMOUS VEHICLE SENSOR CALIBRATION ALGORITHM EVALUATION

(71) Applicant: GM Cruise Holdings LLC, San Francisco, CA (US)

(72) Inventors: Annett Bordoley, Seattle, WA (US); Ankit Rohatgi, Pacifica, CA (US); Zhonghua Ma, San Jose, CA (US)

(21) Appl. No.: 17/945,952

(22) Filed: Sep. 15, 2022

(51) Int. Cl. B60W 50/06; B60W 50/02

(52) U.S. Cl. CPC B60W 50/06; B60W 50/0205; B60W 2050/0215; B60W 2420/42; B60W 2420/52; B60W 2520/14; B60W 2520/18

(57) ABSTRACT

The disclosed technology provides solutions for evaluating sensor calibration algorithms and in particular, for evaluating calibration mechanisms used in autonomous vehicle (AV) deployments. The disclosed technology encompasses a process that includes steps for determining calibration parameters for a sensor mounted to an autonomous vehicle (AV), determining a fault injection offset for at least one of the one or more calibration parameters, and modifying at least one of the one or more calibration parameters based on the fault injection offset. The process may additionally include steps for collecting sensor data from the sensor and evaluating a calibration algorithm associated with the sensor based on the fault injection offset and sensor data. Systems and machine-readable media are also provided.

### BACKGROUND

### 1. Technical Field

The disclosed technology provides solutions for evaluating sensor calibration algorithms and in particular, for evaluating online calibration mechanisms used in autonomous vehicle (AV) deployments.

### 2. Introduction

Autonomous vehicles (AVs) are vehicles having computers and control systems that perform driving and navigation tasks that are conventionally performed by a human driver. As AV technologies continue to advance, they will be increasingly used to improve transportation efficiency and safety. As such, AVs will need to perform many of the functions that are conventionally performed by human drivers, such as performing navigation and routing tasks necessary to provide safe and efficient transportation. Such tasks may require the collection and processing of large quantities of data using various sensor types, including but not limited to cameras and/or Light Detection and Ranging (LiDAR) sensors disposed on the AV. In some instances, the collected data can be used by the AV to perform tasks relating to routing, planning and obstacle avoidance.

### BRIEF DESCRIPTION OF THE DRAWINGS

Certain features of the subject technology are set forth in the appended claims. However, the accompanying drawings, which are included to provide further understanding, illustrate disclosed aspects and together with the description explain the principles of the subject technology. In the drawings:

FIG. 1 illustrates an example of sensor miscalibration with respect to an autonomous vehicle (AV).

FIG. 2 illustrates a flow diagram of processing steps that can be used to test/validate AV sensor calibration algorithms or checkers, according to some aspects of the disclosed technology.

FIG. 3 illustrates a flow diagram of an example process for validating the performance of a sensor calibration algorithm or checker, according to some aspects of the disclosed technology.

FIG. 4 illustrates an example system environment that can be used to facilitate AV dispatch and operations, according to some aspects of the disclosed technology.

FIG. 5 illustrates an example processor-based system with which some aspects of the subject technology can be implemented.

### DETAILED DESCRIPTION

The detailed description set forth below is intended as a description of various configurations of the technology and is not intended to represent the only configurations that can be practiced. The appended drawings are incorporated herein and constitute a part of the detailed description. The detailed description includes specific details for the purpose of providing a more thorough understanding of the subject technology. However, it will be clear and apparent that the subject technology is not limited to the specific details set forth herein and may be practiced without these details. In some instances, structures and components are shown in block diagram form to avoid obscuring certain concepts.

As described herein, one aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

Autonomous vehicles (AVs) use sensors of various types to gather information (sensor data) about a surrounding environment. The sensor data can be consumed by an AV stack to provide perception and planning functions, among others. Although any available sensor types may be implemented for use on an AV, AV sensors can include one or more: Light Detection and Ranging (LiDAR) sensors, Radio Detection Raging (RADAR) sensors, ultrasonic sensors, camera sensors, etc.

Because of the myriad of variables that can affect sensor calibration, in many AV deployments, sensors for each vehicle are calibrated before the vehicle deployment. Sensor calibration information (also: sensor calibration parameters/data, or calibration parameters/data) for each sensor can be stored for use when operating the associated sensor. As used herein, calibration parameters can include any software and/or firmware parameters that affect how sensor data is collected. By way of example, sensor calibration parameters may indicate a relative displacement in three-dimensional (3D) space, such as by specifying roll, tilt, and/or yaw information relating to the positioning of an associated sensor, e.g., with respect to a corresponding vehicle (or AV).

In some implementations, sensor calibration information for each sensor on a given vehicle may be stored to a network accessible memory device, and/or downloaded to the vehicle before deployment. Additionally, vehicle deployment may be performed in a simulated environment. That is, the calibration parameters may be applied to a virtual sensor that is operated in a simulated environment (SIM), e.g., to emulate the performance of AVs and/or sensors, without the need to deploy a physical vehicle.

To ensure that the sensor calibration parameters remain accurate during vehicle operation (in either real-world scenarios, or in SIM), one or more calibration algorithms (or calibration checkers) can be run on the AV, e.g., as an on-line calibration process. The on-line calibration process can be performed continuously, at periodic intervals, during AV operation. In some approaches for example, calibration checks may be performed every 10 seconds, or every 20 seconds, depending on a velocity of the associated AV.

When operating properly, calibration algorithms can detect when sensors have succumbed to miscalibration, e.g., to a loss in the accuracy of sensor data received by a particular sensor. By way of example, properly functioning calibration algorithms can detect when a sensor (e.g., a LiDAR, camera, RADAR, etc.) has become misaligned from an intended position on the AV, e.g., due to mechanical displacement caused by road vibrations, collisions, or other physical perturbations.

To identify a mis-calibration event, the calibration algorithms may utilize feeds of sensor data from multiple sensors, for example, to compare data received from each sensor and determine if a mis-calibration has occurred. By way of example, cross-sensor alignment checks can be performed to identify discontinuities in sensor data from different sensors of the same modality, such as from different LiDAR sensors, e.g., when LiDAR point clouds from the different LiDAR sensors do not align. Additionally, cross-sensor alignment checks can be performed for sensors of different modalities, such as by performing alignment checks between cameras and LiDARs, e.g., using (camera) collected image data, and (LiDAR) collected point-cloud data. In instances where alignments are checked between sensors of different modalities, the checks can be performed by comparing object geometries or other salient features commonly represented in sensor data for all sensor modality types. However, in some AV deployments, there is no way to check or validate the performance/accuracy of the calibration algorithms.

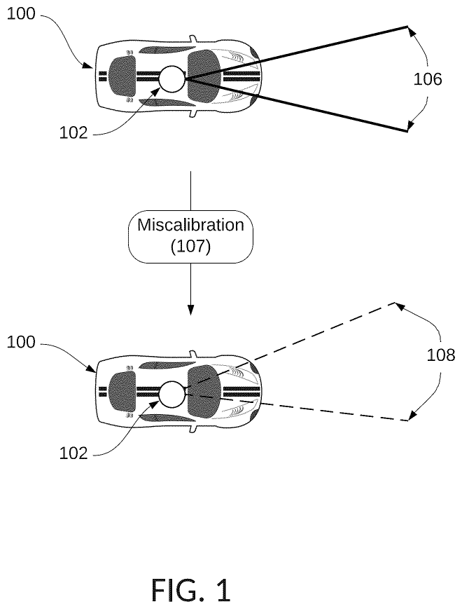

Aspects of the disclosed technology provide solutions for evaluating sensor calibration algorithms and in particular, for evaluating online calibration mechanisms used in autonomous vehicle (AV) deployments. In some aspects, calibration algorithm performance can be evaluated by perturbing sensor data values (e.g., by modifying one or more sensor parameters by introducing a fault injection offset), and evaluating the ability of the calibration algorithm to detect the resulting miscalibration state. Further details relating to the user of fault injection offsets are discussed in further detail with respect to FIG. 1, below.

FIG. 1 illustrates an example sensor miscalibration with respect to an autonomous vehicle 100. In the illustrated example, autonomous vehicle 100 includes a sensor 102 that is calibrated to monitor a field-of-view (FOV) 106 of the AV environment.

The effect of a miscalibration event 107, such as a collision or other mechanical disturbance that changes a physical position of sensor 102, is represented by a change or shift in the FOV corresponding with sensor 102. For example, FOV 108 represents a coverage by sensor 102 resulting from miscalibration event 107.

In an ideal scenario, calibration algorithms (or calibration processes) running on vehicle 100 should detect the miscalibration of sensor 102 resulting from miscalibration event 107. However, for some calibration algorithms, there is (1) no way to verify or validate that the algorithm is functioning and can capably identify faulty sensor calibration conditions, and (2) there is no way to determine the accuracy/sensitivity/performance of the calibration algorithm/calibration checking process.

Aspects of the disclosed technology provide solutions for estimating and/or validating the accuracy of sensor calibration algorithms/checkers. According to some embodiments, calibration algorithm performance can be assessed by applying an offset (e.g., a fault injection) to one or more configuration parameters for a given sensor, for example, to mimic a miscalibration event (e.g., miscalibration event 107), such as the mechanical displacement of a LiDAR, camera, or RADAR sensor along one or more spatial axes, e.g., a tilt, roll, and/or yaw axis. As such, the fault injection can transform the collected sensor data in a manner that emulate changes that can result from a miscalibration event, such as an AV collision, or the like.

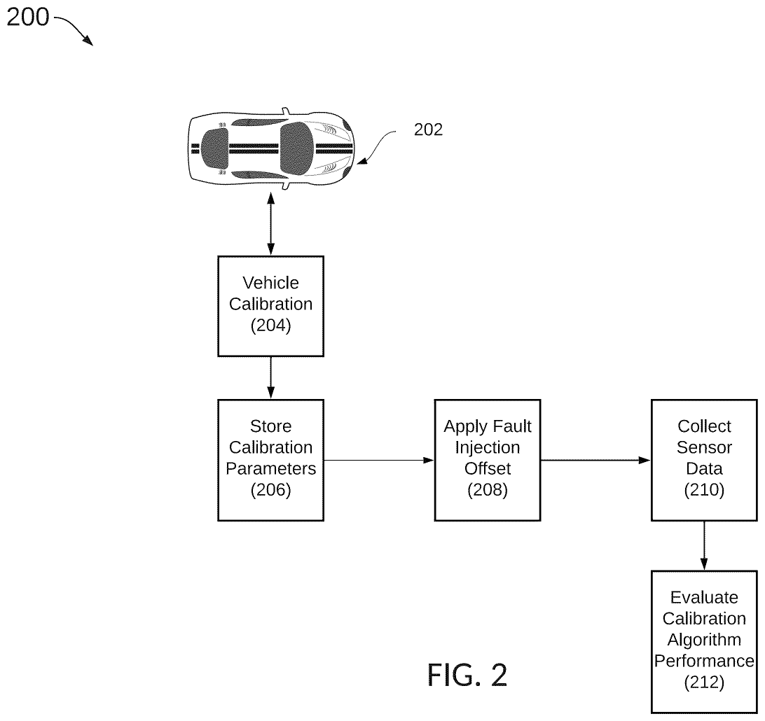

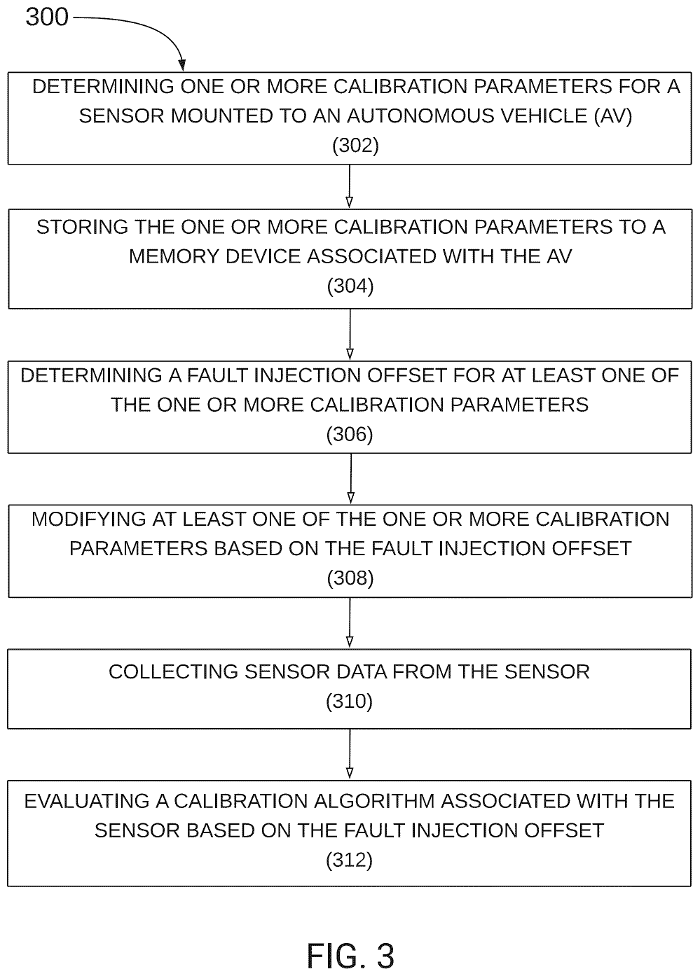

A fault injection process of the disclosed technology can be used to systematically test the operating state or performance of one or more calibration checkers. Additionally, in some instances, the process may be used to test or validate an accuracy of the calibration checkers. Further details regarding a process for validating calibration checkers is provided in further detail with respect to FIGS. 2-3, below.

FIG. 2 illustrates a flow diagram of processing steps 200 that can be used to test/validate AV sensor calibration algorithms (or calibration checkers), according to some aspects of the disclosed technology. At block 204, a calibration process is performed with respect to AV 202, for example, whereby various calibration parameters are determined/identified for one or more sensors (not illustrated) of AV 202. An initial vehicle calibration 204 can be performed using an AV calibration process whereby sensor data is collected by various sensors about a staged visual environment, such as a calibration environment that has been designed to aid in identifying or determining optimal sensor configuration parameters. By way of example, a calibration environment may include various visual targets (calibration targets) that have known geometric or other visual properties, such as optical patterns, and that can be used to calibrate sensor data collection by various sensors of AV 202.

Once the various sensor calibration parameters for vehicle 202 are determined, the calibration parameters can be stored (block 206), for example, to a memory device that is associated with the AV 202. The calibration parameters for one or more sensors may be stored to a network connected storage device. In such instances, calibration parameters may be downloaded to AV 202 before deployment, e.g., saved to one or more memory devices associated with the one or more AV sensors. In other aspects, the calibration parameters may be stored to a storage database where they can be accessed in a simulated (SIM) environment.

At block 208, a fault injection offset can be determined (or selected) and applied for one or more sensors of the AV 202. In some approaches, the fault injection offset can be determined on a sensor-by-sensor basis, e.g., based on the sensor modality (or sensor type) for which the offset is applied, and/or based on the operating range for the target sensor. By way of example, a fault injection offset for a LiDAR sensor may be different from that calculated for a camera and/or RADAR sensor, etc. Additionally, the fault injection offset can be based on the specific sensor parameter that the offset is configured to modify. For example, if a set of configuration parameters for a LiDAR sensor specify tilt, roll, and yaw angle displacements, the fault injection offset applied to the tilt parameter/s may be different from those applied to the roll and/or yaw parameter/s, and vice versa. By way of example, the applied fault injection offset may specify a +5-degree offset for the tilt parameter of a camera sensor, or a −15-degree offset of the roll parameter, etc. Depending on the desired implementation, fault injections may be applied to one or more sensor parameters of a given sensor. In some aspects, the fault injection offset may be determined based on an operating range for a specific calibration parameter. Further to the above example, a fault injection offset that modifies a tilt calibration parameter may be based on the operating range of the tilt parameter for the associated sensor (e.g., a LiDAR sensor).

In instances where driving of AV 202 is performed in a real-world driving scenario (e.g., not in a simulation environment), application of the fault injection offset to one or more calibration parameters can include updating sensor calibration parameters stored to a memory device on-vehicle, such as by overwriting calibration parameters associated with one or more AV mounted sensors. In instances where driving of AV 202 is performed in a simulated environment, application of the fault injection offset to one or more sensor calibration parameters can include updating configurations of virtual or emulated sensors of a similar type in the SIM environment.

Fault injection offsets can be represented by a bias or numeric displacement that is applied to one or more calibration parameter values. In some aspects, the bias/offset amount of the fault injection may be a static quantity, i.e., a fixed value. In other aspects, it may be a function of the value of the initial calibration parameter. That is, the offset can be based on (or can be a function of) the calibration parameter value being modified.

At block 210, additional sensor data can be collected by one or more sensors, including the sensor/s for which fault injection offsets were applied. As discussed above, sensor data collection may be performed in a physical real-world driving scenario, and/or in a synthetic/simulated (SIM) environment that is used to model operations and behavior of AV 202. In approaches where SIM environments are used, operation of the sensor can be simulated in a synthetic (or SIM/virtual) environment by generating synthetic sensor data based on one or more objects in the SIM environment. Using the collected sensor data from block 210, evaluations about the performance of one or more sensor calibration algorithms can be made (block 212).

If the miscalibration introduced by the fault injection offset (block 208) is not detected by the calibration algorithms based on the newly/recently collected sensor data (block 210), then it may be determined that the calibration algorithms are not functioning, or are not performing to expectation. However, if the calibration algorithms detect the miscalibration introduced by the fault injection offset, then it may be determined that they are properly functioning.

In some applications, sensor calibration algorithm performance may be tested (or determined) by comparing the fault injection offset to the amount of miscalibration (or misalignment) detected by the calibration algorithm. By way of example, of the fault injection offset introduced a +5-degree offset in the tilt of sensor data collected for a specific LiDAR sensor, and calibration algorithm registers a +5-degree shift along the tilt axis, then it may be determined that the calibration algorithms are functioning properly. In the same example, if the calibration algorithms were to register a miscalibration of −10-degrees along the tilt axis, or a shift with respect to another spatial dimension (e.g., the roll and/or yaw axes), then it may be determined that the calibration algorithms are poorly performing. Determinations regarding acceptable error variance for the calibration algorithms may depend on a variety of factors, including but not limited to a complexity of the environment being navigated by the AV (e.g., scene complexity), vehicle speed, and/or measures of performance for various other AV sensors, etc.

FIG. 3 illustrates a flow diagram of an example process 300 for validating the performance of a sensor calibration algorithm or checker, according to some aspects of the disclosed technology.

At step 302, the process 300 includes determining one or more calibration parameters (or initial sensor parameters) for a sensor mounted to an autonomous vehicle (AV). In some approaches, initial sensor calibration may be performed using an AV calibration process whereby sensor data is collected by various sensors about a staged visual environment, such as a calibration environment that has been designed to aid in identifying or determining optimal sensor configuration parameters. By way of example, a calibration environment may include various visual targets composed of known optical and/or geometric patterns, and that are disposed at known and fixed locations around the AV.

At step 304, the process 300 includes storing the one or more calibration parameters to a memory device associated with the AV. Depending on the desired implementation, the calibration parameters may be stored to a network device and then downloaded to the AV prior to deployment. In some approaches, the AV sensor may be emulated in simulation (SIM). In such instances, parameter values for the (SIM) sensor can be stored to a network accessible storage device, (e.g., a database) that is capable of providing the calibration parameter data into a SIM environment, for example, that may be used to perform testing of the AV.

In other approaches, the calibration parameters may be stored to a memory device that is local to the AV associated with the corresponding (physical) sensors. By way of example, a set of calibration parameters for a left-front LiDAR unit of the AV may be stored to a memory device that is local to, and housed by, the left-front LiDAR unit. Similarly, calibration parameters for a right-front camera unit of the AV may be stored to a memory device that corresponds by the right-front camera unit.

At step 306, the process 300 includes determining a fault injection offset for at least one of the one or more calibration parameters. Fault injection offsets can be represented by a bias or numeric displacement that is applied to one or more calibration parameter values. The offset can be based on (or can be a function of) the calibration parameter value being modified. In some aspects, the fault injection offset can be based on the type of parameter to be modified and/or a sensitivity of sensor response to the corresponding parameter. For example, fault injection values for a tilt parameter of a LiDAR unit may be different from those for a yaw parameter of the same LiDAR unit, e.g., depending on sensitivity of modification as between tilt and yaw offsets.

At step 308, the process 300 includes modifying at least one of the one or more calibration parameters based on the fault injection offset. In some approaches, the modification of the one or more calibration parameters can be performed by overwriting (or temporarily overwriting) legacy/stored values with new calibration parameter values determined in step 306. In some instances, the fault injection offset (or fault injection offset value) can be selected based on a normal or valid operating range for the sensor. Additionally, the fault injection offset may be based on the calibration parameter to be modified/overwritten. By way of example, for a LiDAR sensor, a fault injection offset for one or more parameters corresponding with a pitch angle parameter may be based on the standard operating ranges for LiDAR sensors, generally, as well as tolerances for pitch angle specifically.

In another example, the fault injection offset may be based on operating ranges for a given sensor. Further to the above example, the selected fault injection offset may be based on operating ranges for the LiDAR sensor for which the one or more calibration parameters are to be modified.

At step 310, the process 300 includes collecting sensor data from the sensor. As discussed above, sensor data collection can occur in real-world driving scenarios, or may be performed in a simulated (SIM) environment. As such, various AV sensors can be virtually implemented (or simulated sensors) that are assigned calibration parameters to mimic the behavior and performance of a physical, AV mounted, sensor.

At step 312, the process 300 includes evaluating a calibration algorithm associated with the sensor based on the fault injection offset and the sensor data. Calibration algorithm evaluations can be performed to determine (1) if the calibration algorithm is properly functioning and capable of detecting/identifying a sensor miscalibration, e.g., in one or more sensors; and/or (2) can be performed to determine a degree of accuracy or sensitivity of the calibration algorithms.

By way of example, the miscalibration caused by the fault injection can be used to determine if the calibration algorithm is functioning. In such approaches, the fault injection offset can be used to modify one or more sensor configuration parameters, and the calibration algorithm/process can be run to determine if the miscalibration event is identified.

In some approaches, calibration algorithm accuracy may be evaluated by using a pre-determined calibration offset threshold. By way of example, if the offset threshold is 5 degrees, then a fault injection may be used to modify one or more sensor calibration parameters to cause a miscalibration of the sensor that totals 6 degrees. Subsequently, collected sensor data can be provided to the calibration algorithm e.g., to determine if the miscalibration event is identified. In this example, the fault injection process can be used to verify calibration algorithm accuracy or sensitivity to sensor miscalibration states within a range of acceptable error (e.g., 5 degrees).

Depending on the desired implementation, calibration algorithm evaluation may utilize sensor data generated by one or more AV sensors that are not subject to miscalibration (e.g., fault injection offset). In some approaches, the calibration algorithm evaluation may be performed with respect to sensor data collected by two or more sensors that have been miscalibrated via a fault injection offset.

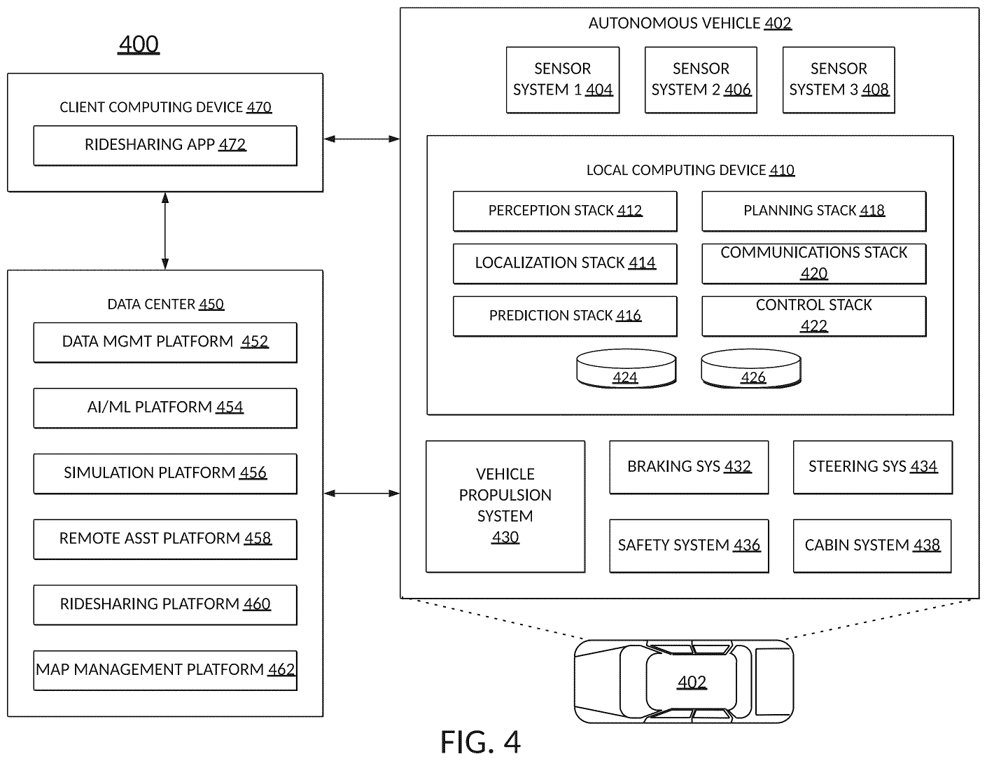

FIG. 4 illustrates an example of an AV management system 400. One of ordinary skill in the art will understand that, for the AV management system 400 and any system discussed in the present disclosure, there can be additional or fewer components in similar or alternative configurations. The illustrations and examples provided in the present disclosure are for conciseness and clarity. Other embodiments may include different numbers and/or types of elements, but one of ordinary skill the art will appreciate that such variations do not depart from the scope of the present disclosure.

AV management system 400 includes an AV 402, a data center 450, and a client computing device 470. The AV 402, the data center 450, and the client computing device 470 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

AV 402 can navigate roadways without a human driver based on sensor signals generated by multiple sensor systems 404, 406, and 408. The sensor systems 404-408 can include different types of sensors and can be arranged about the AV 402. For instance, the sensor systems 404-408 can comprise Inertial Measurement Units (IMUs), cameras (e.g., still image cameras, video cameras, etc.), optical sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 404 can be a camera system, the sensor system 406 can be a LIDAR system, and the sensor system 408 can be a RADAR system. Other embodiments may include any other number and type of sensors.

AV 402 can also include several mechanical systems that can be used to maneuver or operate the AV 402. For instance, the mechanical systems can include a vehicle propulsion system 430, a braking system 432, a steering system 434, a safety system 436, and a cabin system 438, among other systems. The vehicle propulsion system 430 can include an electric motor, an internal combustion engine, or both. The braking system 432 can include an engine brake, brake pads, actuators, and/or any other suitable componentry configured to assist in decelerating the AV 402. The steering system 434 can include suitable componentry configured to control the direction of movement of the AV 402 during navigation. The safety system 436 can include lights and signal indicators, a parking brake, airbags, and so forth. The cabin system 438 can include cabin temperature control systems, in-cabin entertainment systems, and so forth. In some embodiments, the AV 402 might not include human driver actuators (e.g., steering wheel, handbrake, foot brake pedal, foot accelerator pedal, turn signal lever, window wipers, etc.) for controlling the AV 402. Instead, the cabin system 438 can include one or more client interfaces (e.g., Graphical User Interfaces (GUIs), Voice User Interfaces (VUIs), etc.) for controlling certain aspects of the mechanical systems 430-438.

AV 402 can additionally include a local computing device 410 that is in communication with the sensor systems 404-408, the mechanical systems 430-438, the data center 450, and the client computing device 470, among other systems. The local computing device 410 can include one or more processors and memory, including instructions that can be executed by the one or more processors. The instructions can make up one or more software stacks or components responsible for controlling the AV 402; communicating with the data center 450, the client computing device 470, and other systems; receiving inputs from riders, passengers, and other entities within the AV's environment; logging metrics collected by the sensor systems 404-408; and so forth. In this example, the local computing device 410 includes a perception stack 412, a mapping and localization stack 414, a prediction stack 416, a planning stack 418, a communications stack 420, a control stack 422, an AV operational database 424, and an HD geospatial database 426, among other stacks and systems.

Perception stack 412 can enable the AV 402 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 404-408, the mapping and localization stack 414, the HD geospatial database 426, other components of the AV, and other data sources (e.g., the data center 450, the client computing device 470, third party data sources, etc.). The perception stack 412 can detect and classify objects and determine their current locations, speeds, directions, and the like. In addition, the perception stack 412 can determine the free space around the AV 402 (e.g., to maintain a safe distance from other objects, change lanes, park the AV, etc.). The perception stack 412 can also identify environmental uncertainties, such as where to look for moving objects, flag areas that may be obscured or blocked from view, and so forth. In some embodiments, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

Mapping and localization stack 414 can determine the AV's position and orientation (pose) using different methods from multiple systems (e.g., GPS, IMUs, cameras, LIDAR, RADAR, ultrasonic sensors, the HD geospatial database 426, etc.). For example, in some embodiments, the AV 402 can compare sensor data captured in real-time by the sensor systems 404-408 to data in the HD geospatial database 426 to determine its precise (e.g., accurate to the order of a few centimeters or less) position and orientation. The AV 402 can focus its search based on sensor data from one or more first sensor systems (e.g., GPS) by matching sensor data from one or more second sensor systems (e.g., LIDAR). If the mapping and localization information from one system is unavailable, the AV 402 can use mapping and localization information from a redundant system and/or from remote data sources.

Prediction stack 416 can receive information from the localization stack 414 and objects identified by the perception stack 412 and predict a future path for the objects. In some embodiments, the prediction stack 416 can output several likely paths that an object is predicted to take along with a probability associated with each path. For each predicted path, the prediction stack 416 can also output a range of points along the path corresponding to a predicted location of the object along the path at future time intervals along with an expected error value for each of the points that indicates a probabilistic deviation from that point.

Planning stack 418 can determine how to maneuver or operate the AV 402 safely and efficiently in its environment. For example, the planning stack 418 can receive the location, speed, and direction of the AV 402, geospatial data, data regarding objects sharing the road with the AV 402 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 402 from one point to another and outputs from the perception stack 412, localization stack 414, and prediction stack 416. The planning stack 418 can determine multiple sets of one or more mechanical operations that the AV 402 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 418 can select from multiple backup plans to carry out. For example, while preparing to change lanes to turn right at an intersection, another vehicle may aggressively cut into the destination lane, making the lane change unsafe. The planning stack 418 could have already determined an alternative plan for such an event. Upon its occurrence, it could help direct the AV 402 to go around the block instead of blocking a current lane while waiting for an opening to change lanes.

Control stack 422 can manage the operation of the vehicle propulsion system 430, the braking system 432, the steering system 434, the safety system 436, and the cabin system 438. The control stack 422 can receive sensor signals from the sensor systems 404-408 as well as communicate with other stacks or components of the local computing device 410 or a remote system (e.g., the data center 450) to effectuate operation of the AV 402. For example, the control stack 422 can implement the final path or actions from the multiple paths or actions provided by the planning stack 418. This can involve turning the routes and decisions from the planning stack 418 into commands for the actuators that control the AV's steering, throttle, brake, and drive unit.

Communications stack 420 can transmit and receive signals between the various stacks and other components of the AV 402 and between the AV 402, the data center 450, the client computing device 470, and other remote systems. The communications stack 420 can enable the local computing device 410 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 420 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

HD geospatial database 426 can store HD maps and related data of the streets upon which the AV 402 travels. In some embodiments, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include 3D attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

AV operational database 424 can store raw AV data generated by the sensor systems 404-408, stacks 412-422, and other components of the AV 402 and/or data received by the AV 402 from remote systems (e.g., the data center 450, the client computing device 470, etc.). In some embodiments, the raw AV data can include HD LIDAR point cloud data, image data, RADAR data, GPS data, and other sensor data that the data center 450 can use for creating or updating AV geospatial data or for creating simulations of situations encountered by AV 402 for future testing or training of various machine learning algorithms that are incorporated in the local computing device 410.

Data center 450 can be a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and so forth. The data center 450 can include one or more computing devices remote to the local computing device 410 for managing a fleet of AVs and AV-related services. For example, in addition to managing the AV 402, the data center 450 may also support a ridesharing service, a delivery service, a remote/roadside assistance service, street services (e.g., street mapping, street patrol, street cleaning, street metering, parking reservation, etc.), and the like.

Data center 450 can send and receive various signals to and from the AV 402 and the client computing device 470. These signals can include sensor data captured by the sensor systems 404-408, roadside assistance requests, software updates, ridesharing pick-up and drop-off instructions, and so forth. In this example, the data center 450 includes a data management platform 452, an Artificial Intelligence/Machine Learning (AI/ML) platform 454, a simulation platform 456, a remote assistance platform 458, and a ridesharing platform 460, and a map management platform 462, among other systems.

The data management platform 452 can be a “big data” system capable of receiving and transmitting data at high velocities (e.g., near real-time or real-time), processing a large variety of data and storing large volumes of data (e.g., terabytes, petabytes, or more of data). The varieties of data can include data having different structured (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), or data having other heterogeneous characteristics. The various platforms and systems of the data center 450 can access data stored by the data management platform 452 to provide their respective services.

The AI/ML platform 454 can provide the infrastructure for training and evaluating machine learning algorithms for operating the AV 402, the simulation platform 456, the remote assistance platform 458, the ridesharing platform 460, the map management platform 462, and other platforms and systems. Using the AI/ML platform 454, data scientists can prepare data sets from the data management platform 452; select, design, and train machine learning models; evaluate, refine, and deploy the models; maintain, monitor, and retrain the models; and so on.

The simulation platform 456 can enable testing and validation of the algorithms, machine learning models, neural networks, and other development efforts for the AV 402, the remote assistance platform 458, the ridesharing platform 460, the map management platform 462, and other platforms and systems. The simulation platform 456 can replicate a variety of driving environments and/or reproduce real-world scenarios from data captured by the AV 402, including rendering geospatial information and road infrastructure (e.g., streets, lanes, crosswalks, traffic lights, stop signs, etc.) obtained from a cartography platform (e.g., map management platform 462); modeling the behavior of other vehicles, bicycles, pedestrians, and other dynamic elements; simulating inclement weather conditions, different traffic scenarios; and so on.

The remote assistance platform 458 can generate and transmit instructions regarding the operation of the AV 402. For example, in response to an output of the AI/ML platform 454 or other system of the data center 450, the remote assistance platform 458 can prepare instructions for one or more stacks or other components of the AV 402.

The ridesharing platform 460 can interact with a customer of a ridesharing service via a ridesharing application 472 executing on the client computing device 470. The client computing device 470 can be any type of computing system, including a server, desktop computer, laptop, tablet, smartphone, smart wearable device (e.g., smartwatch, smart eyeglasses or other Head-Mounted Display (HMD), smart ear pods, or other smart in-ear, on-ear, or over-ear device, etc.), gaming system, or other general purpose computing device for accessing the ridesharing application 472. The client computing device 470 can be a customer's mobile computing device or a computing device integrated with the AV 402 (e.g., the local computing device 410). The ridesharing platform 460 can receive requests to pick up or drop off from the ridesharing application 472 and dispatch the AV 402 for the trip.

Map management platform 462 can provide a set of tools for the manipulation and management of geographic and spatial (geospatial) and related attribute data. The data management platform 452 can receive LIDAR point cloud data, image data (e.g., still image, video, etc.), RADAR data, GPS data, and other sensor data (e.g., raw data) from one or more AVs 402, Unmanned Aerial Vehicles (UAVs), satellites, third-party mapping services, and other sources of geospatially referenced data. The raw data can be processed, and map management platform 462 can render base representations (e.g., tiles (2D), bounding volumes (3D), etc.) of the AV geospatial data to enable users to view, query, label, edit, and otherwise interact with the data. Map management platform 462 can manage workflows and tasks for operating on the AV geospatial data. Map management platform 462 can control access to the AV geospatial data, including granting or limiting access to the AV geospatial data based on user-based, role-based, group-based, task-based, and other attribute-based access control mechanisms. Map management platform 462 can provide version control for the AV geospatial data, such as to track specific changes that (human or machine) map editors have made to the data and to revert changes when necessary. Map management platform 462 can administer release management of the AV geospatial data, including distributing suitable iterations of the data to different users, computing devices, AVs, and other consumers of HD maps. Map management platform 462 can provide analytics regarding the AV geospatial data and related data, such as to generate insights relating to the throughput and quality of mapping tasks.

In some embodiments, the map viewing services of map management platform 462 can be modularized and deployed as part of one or more of the platforms and systems of the data center 450. For example, the AI/ML platform 454 may incorporate the map viewing services for visualizing the effectiveness of various object detection or object classification models, the simulation platform 456 may incorporate the map viewing services for recreating and visualizing certain driving scenarios, the remote assistance platform 458 may incorporate the map viewing services for replaying traffic incidents to facilitate and coordinate aid, the ridesharing platform 460 may incorporate the map viewing services into the client application 472 to enable passengers to view the AV 402 in transit en route to a pick-up or drop-off location, and so on.

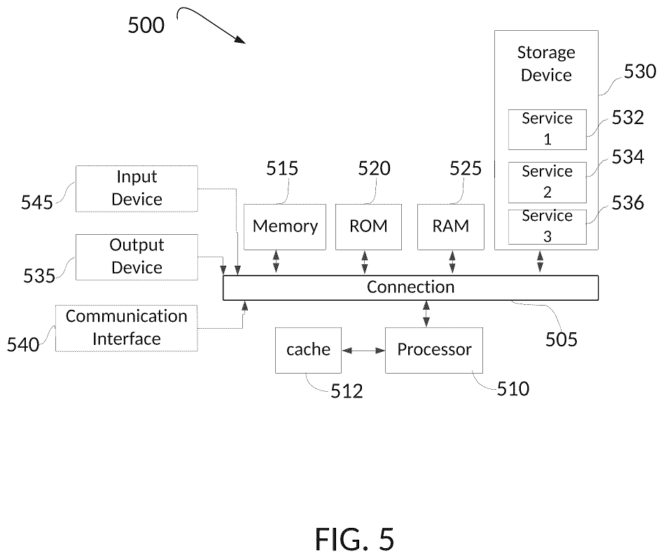

FIG. 5 illustrates an example apparatus (e.g., a processor-based system) with which some aspects of the subject technology can be implemented. For example, processor-based system 500 can be any computing device making up internal computing system 510, remote computing system/data center 450, a passenger device executing the rideshare app 470, internal computing device 530, or any component thereof in which the components of the system are in communication with each other using connection 505. Connection 505 can be a physical connection via a bus, or a direct connection into processor 510, such as in a chipset architecture. Connection 505 can also be a virtual connection, networked connection, or logical connection.

In some embodiments, computing system 500 is a distributed system in which the functions described in this disclosure can be distributed within a datacenter, multiple data centers, a peer network, etc. In some embodiments, one or more of the described system components represents many such components each performing some or all of the functions for which the component is described. In some embodiments, the components can be physical or virtual devices.

Example system 500 includes at least one processing unit (CPU or processor) 510 and connection 505 that couples various system components including system memory 515, such as read-only memory (ROM) 520 and random-access memory (RAM) 525 to processor 510. Computing system 500 can include a cache of high-speed memory 512 connected directly with, in close proximity to, or integrated as part of processor 510.

Processor 510 can include any general-purpose processor and a hardware service or software service, such as services 532, 534, and 536 stored in storage device 530, configured to control processor 510 as well as a special-purpose processor where software instructions are incorporated into the actual processor design. Processor 510 may essentially be a completely self-contained computing system, containing multiple cores or processors, a bus, memory controller, cache, etc. A multi-core processor may be symmetric or asymmetric.

To enable user interaction, computing system 500 includes an input device 545, which can represent any number of input mechanisms, such as a microphone for speech, a touch-sensitive screen for gesture or graphical input, keyboard, mouse, motion input, speech, etc. Computing system 500 can also include output device 535, which can be one or more of a number of output mechanisms known to those of skill in the art. In some instances, multimodal systems can enable a user to provide multiple types of input/output to communicate with computing system 500. Computing system 500 can include communications interface 540, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communication interface 540 may also include one or more Global Navigation Satellite System (GNSS) receivers or transceivers that are used to determine a location of the computing system 500 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 530 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L#), resistive random-access memory (RRAM/ReRAM), phase change memory (PCM), spin transfer torque RAM (STT-RAM), another memory chip or cartridge, and/or a combination thereof.

Storage device 530 can include software services, servers, services, etc., that when the code that defines such software is executed by the processor 510, it causes the system to perform a function. In some embodiments, a hardware service that performs a particular function can include the software component stored in a computer-readable medium in connection with the necessary hardware components, such as processor 510, connection 505, output device 535, etc., to carry out the function.

As understood by those of skill in the art, machine-learning based classification techniques can vary depending on the desired implementation. For example, machine-learning classification schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include including but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Embodiments within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special purpose computer, or special purpose processing device to perform a certain function or group of functions. Computer-executable instructions also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The sequence of such executable instructions or associated data structures represents examples of corresponding acts for implementing the functions described in such steps.

Other embodiments of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Embodiments may also be practiced in distributed computing environments where tasks are performed by local and remote processing devices that are linked (either by hardwired links, wireless links, or by a combination thereof) through a communications network. In a distributed computing environment, program modules may be located in both local and remote memory storage devices.

The various embodiments described above are provided by way of illustration only and should not be construed to limit the scope of the disclosure. For example, the principles herein apply equally to optimization as well as general improvements. Various modifications and changes may be made to the principles described herein without following the example embodiments and applications illustrated and described herein, and without departing from the spirit and scope of the disclosure. Claim language reciting “at least one of” a set indicates that one member of the set or multiple members of the set satisfy the claim.

What is claimed is:

1. A computer-implemented method comprising:
determining one or more calibration parameters for a sensor mounted to an autonomous vehicle (AV);
storing the one or more calibration parameters to a memory device associated with the AV;
determining a fault injection offset for at least one of the one or more calibration parameters;
modifying at least one of the one or more calibration parameters based on the fault injection offset;
collecting sensor data from the sensor; and
evaluating a calibration algorithm associated with the sensor based on the fault injection offset and the sensor data.

2. The computer-implemented method of claim 1, wherein the fault injection offset is determined based on at least one of: an operating range for the sensor, or the sensor type.

3. The computer-implemented method of claim 1, wherein evaluating the calibration algorithm comprises:
determining if the calibration algorithm detects a miscalibration of the sensor that results from modifying the at least one of the one or more calibration parameters based on the fault injection offset.

4. The computer-implemented method of claim 1, wherein evaluating the calibration algorithm comprises:
determining if the calibration algorithm detects a calibration offset of the sensor resulting from modifying the at least one of the one or more calibration parameters based on the fault injection offset.

5. The computer-implemented method of claim 1, wherein collecting the sensor data from the sensor further comprises:
simulating operation of the sensor in a synthetic environment by generating synthetic sensor data based on one or more objects in the synthetic environment.

6. The computer-implemented method of claim 1, wherein the one or more calibration parameters represent a roll offset, a tilt offset, or a yaw offset for an AV sensor, or a combination thereof.

7. The computer-implemented method of claim 1, wherein the sensor is a Light Detection and Ranging (LiDAR) sensor, a Radio Detection and Ranging (RADAR) sensor, a camera sensor, or a combination thereof.

8. An apparatus comprising:
at least one memory; and
at least one processor coupled to the at least one memory, the at least one processor configured to:
determine one or more calibration parameters for a sensor mounted to an autonomous vehicle (AV);
store the one or more calibration parameters to a memory device associated with the AV;
determine a fault injection offset for at least one of the one or more calibration parameters;
modify at least one of the one or more calibration parameters based on the fault injection offset;
collecting sensor data from the sensor; and
evaluating a calibration algorithm associated with the sensor based on the fault injection offset and the sensor data.

9. The apparatus of claim 8, wherein the fault injection offset is based on at least one of: an operating range for the sensor, or the sensor type.

10. The apparatus of claim 8, wherein to evaluate the calibration algorithm, the at least one processor is further configured to:
determine if the calibration algorithm detects a miscalibration of the sensor that results from modifying the at least one of the one or more calibration parameters based on the fault injection offset.

11. The apparatus of claim 8, wherein to evaluate the calibration algorithm, the at least one processor is further configured to:
determining if the calibration algorithm detects a calibration offset of the sensor resulting from modifying the at least one of the one or more calibration parameters based on the fault injection offset.

12. The apparatus of claim 8, wherein to collect the sensor data from the sensor, the at least one processor is further configured to:
simulate operation of the sensor in a synthetic environment by generating synthetic sensor data based on one or more objects in the synthetic environment.

13. The apparatus of claim 8, wherein the one or more calibration parameters represent a roll offset, a tilt offset, a yaw offset for an AV sensor, or a combination thereof.

14. The apparatus of claim 8, wherein the sensor wherein the sensor is a Light Detection and Ranging (LiDAR) sensor, a Radio Detection and Ranging (RADAR) sensor, a camera sensor, or a combination thereof.

15. A non-transitory computer-readable storage medium comprising at least one instruction for causing a computer or processor to:
determine one or more calibration parameters for a sensor mounted to an autonomous vehicle (AV);
store the one or more calibration parameters to a memory device associated with the AV;
determine a fault injection offset for at least one of the one or more calibration parameters;
modify at least one of the one or more calibration parameters based on the fault injection offset;
collect sensor data from the sensor; and
evaluate a calibration algorithm associated with the sensor based on the fault injection offset and the sensor data.

16. The non-transitory computer-readable storage medium of claim 15, wherein the fault injection offset determined based on at least one of: an operating range for the sensor, or the sensor type.

17. The non-transitory computer-readable storage medium of claim 15, wherein to evaluate the calibration algorithm, the at least one instruction is further configured to cause the processor to:
determine if the calibration algorithm detects a miscalibration of the sensor that results from modifying the at least one of the one or more calibration parameters based on the fault injection offset.

18. The non-transitory computer-readable storage medium of claim 15, wherein to evaluate the calibration algorithm, the at least one instruction is further configured to cause the processor to:
determine if the calibration algorithm detects a calibration offset of the sensor resulting from modifying the at least one of the one or more calibration parameters based on the fault injection offset.

19. The non-transitory computer-readable storage medium of claim 15, wherein to collect the sensor data from the sensor, the at least one instruction is further configured to cause the processor to:
simulate operation of the sensor in a synthetic environment by generating synthetic sensor data based on one or more objects in the synthetic environment.

20. The non-transitory computer-readable storage medium of claim 15, wherein the one or more calibration parameters represent a roll offset, a tilt offset, or a yaw offset for an AV sensor, or a combination thereof.
